(19) United States
(12) Patent Application Publication
(10) Pub. No.: US 2003/0010762 A1
(43) Pub. Date: Jan. 16, 2003

(54) Laser processing apparatus and laser processing method

(75) Inventor: Jun Koide, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/173,855

(22) Filed: Jun. 19, 2002

(30) Foreign Application Priority Data
Jun. 22, 2001 (JP) 190207/2001 (PAT.

(51) Int. Cl. B23K 26/067

(52) U.S. Cl. 219/121.73; 219/121.77; 219/121.85

(57) ABSTRACT

A laser processing apparatus, which performs light ablation process using laser beam from a laser oscillator continuously emitting light pulse having large spatial and temporal energy concentration at pulse emission time of 1 pico second or less, comprises beam dividing means for dividing laser beam from the laser oscillator into plural beams, and optical systems provided separately for each of the divided beams. With the structure thus arranged, it is made possible for the laser processing apparatus to perform plural processing portions altogether by irradiating laser to them at a time through the optical systems without allowing excessive energy to be generated, thus effectively utilizing energy needed for processing for the increased efficiency thereof, contributing to the enhancement of productivity.

### BACKGROUND OF THE INVENTION

1. Field of the Invention

The present invention relates to a laser processing apparatus that forms a structure on a work piece by use of laser beam, and a laser processing method therefor. More particularly, the invention relates to a laser processing apparatus that performs micro processing effectively for micro-machines or complex material and complicated configurations, such as IC and hybrid IC devices, and also, relates to a laser processing method therefore.

2. Related Background Art

Conventionally, it has been practiced to use higher harmonic waves of excimer laser or YAG laser for the formation of a structure by means of laser micro processing.

However, for these processing methods, the maximum energy concentration of laser beam is at a level of 100 mega watts in terms of oscillating pluses. As a result, it is difficult to process a work piece formed by inorganic material. Under the circumstances, only sublimating ablation process is possible for a work piece mainly formed by organic material.

Thus, when micro processing is given to a work piece formed by inorganic material, lithographic process is adopted for the execution of a series of processes, such as resist coating, resist patterning exposure, resist development, etching that utilizes resist pattern, and resist ashing, for each individual material of different property, respectively, when processing a structure. The adoption of a processing method of the kind makes the processing steps complicated, leading to problems related to costs. Also, there is a problem that the investments in the production facilities tend to become enormous against the process tact time. In order to improve the situation thus encountered, the applicant hereof has proposed a sublimation processing in the specification of Japanese Patent Application Laid-Open No. 11-316760 and others, in which when a structure is formed by micro processing on a work piece formed by inorganic material, the laser beam oscillated from a laser oscillator, which outputs laser beam at a pulse emission time of 1 pico second or less, is converged and irradiated onto the work piece in a designated energy concentration. In this way, the temporal energy concentration is significantly increased, and the energy concentration of the emitted laser beam reaches a level of approximately 3 giga watts (here, among generally available laser oscillators on the market, there exists the one having the pulse emission time of 150 femto seconds or less with light energy per pulse being 500 micro joules or more).

Beside this, the applicant hereof has also proposed a laser processing method for the execution of sublimating ablation process that utilizes the characteristics of extremely short laser irradiation time, in which laser beam is not transformed to thermal energy but directly converted into the energy that cuts lattice coupling.

Nevertheless, the laser beam oscillated from the oscillator, which outputs laser beam at a pulse emission time of 1 pico second or less as described above, is generally the laser developed by reproducing amplification inductive emission of seed light. As a result, the diameter of the laser beam is as small as approximately Φ10 mm or less. Moreover, the transverse mode thereof is single, and it has coherent light with a high coherence. Therefore, unlike excimer laser, this laser beam cannot perform the collectively uniform irradiation of photo-mask pattern by use of an optical integrator, such as a homogenizer, due to such coherence. As a result, when an arrangement pattern should be processed, laser flux is allowed to pass a certain one pattern, and induced to irradiate a work piece with the step and repeat operation, which must be repeated. Also, when a continuous pattern should be processed, it may be possible to adopt a method whereby to process it by drawing a pattern by means of scanning of later beam. In this case, however, the control of etching depth depends on the overlapping of the scanning speed and the scanning position.

Under these circumstances, there is still a room for improvement with respect to the processing efficiency, such as to process a desired pattern collectively on a work piece in a short period of time by use of the laser beam oscillated from the laser oscillator that outputs laser beam at a pulse emission time of 1 pico second or less as described above. Now, among the laser oscillators that output laser beam at pulse emission time of 1 pico second or less, which are currently available on the market in general, there is the one the output of which reaches a level of approximately 3 giga watts. Therefore, the energy exerted by the laser beam emitted from such oscillator, which is necessarily applied to processing a work piece, is not even a half of the total energy of the laser beam emitted from such oscillator. The energy needed for processing is often several % thereof or less.

### SUMMARY OF THE INVENTION

Here, therefore, the present invention is designed to aim at providing a laser processing apparatus capable of efficiently utilizing the energy, which is needed for processing, without generating any excessive energy when using the laser beam oscillated from the laser oscillator that outputs laser beam at pulse emission time of 1 pico second or less, hence implementing the enhancement of productivity with the increased processing efficiency, as well as to aim at providing a laser processing method therefor.

In order to achieve such aims, the laser processing apparatus of the present invention, which performs light ablation process using laser beam from a laser oscillator continuously emitting light pulse having large spatial and temporal energy concentration at pulse emission time of 1 pico second or less, comprises beam dividing means for dividing laser beam from the laser oscillator into plural beams, and optical systems provided separately for each of the divided beams. With the structure thus arranged, it is made possible for the laser processing apparatus to perform plural processing portions altogether by irradiating laser to plural processing portions at a time through the optical systems.

Also, the laser processing method of the invention for performing light ablation process, which uses laser beam from a laser oscillator continuously emitting light pulse having large spatial and temporal energy concentration at pulse emission time of 1 pico second or less, comprises the steps of dividing laser beam from the laser oscillator into plural beams; and processing plural processing portions altogether by irradiating laser to plural processing portions simultaneously through individual optical system per divided beam.

In accordance with the present invention, a structure is arranged to process by use of the laser beam oscillated from the laser oscillator that outputs laser beam at pulse emission time of 1 pico second or less, and laser beam is divided into plural beams for processing, and then, plural work pieces are irradiated by laser simultaneously through individual optical system per divided beam. In this manner, when laser processing is performed, excessive energy is not allowed to be generated, hence making it possible to effectively utilize energy needed for processing and implement the enhancement of productivity with such increased processing efficiency.

### BRIEF DESCRIPTION OF THE DRAWINGS

FIG. 1 is a view that schematically shows the optical path of laser beam splitting means of a laser processing apparatus in accordance with the embodiment of the present invention; and

FIG. 2 is a view that schematically shows the photo-mask projection optical system of the laser processing apparatus in accordance with the embodiment of the present invention.

### DETAILED DESCRIPTION OF THE PREFFERED EMBODIMENT

By the application of the aforesaid structure embodying the present invention, it becomes possible to process many numbers of work pieces at a time depending on the divided numbers of laser beam energy when executing the process by use of the laser beam oscillated from the laser oscillator that outputs them at a pulse emission time of 1 pico second or less. As a result, when the same processes are executed in parallel, the processing efficiency is enhanced, and the productivity is improved. Also, it becomes possible to execute different processes in parallel. To utilize only the energy needed for a process efficiently makes it possible to improve processing efficiency, leading to the enhancement of productivity. Particularly, inorganic amorphous material can be processed sufficiently by the application of the converged concentration of the laser beam, because the coupling energy thereof is weak.

Hereinafter, in conjunction with the accompanying drawings, the embodiment will be described in accordance with the present invention.

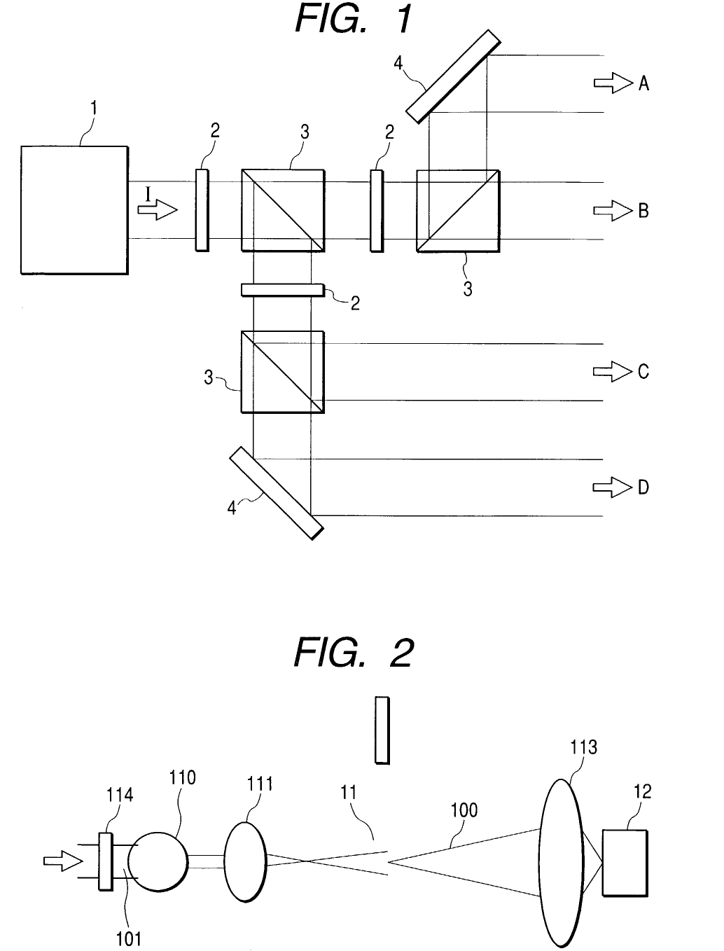

FIG. 1 is a view that schematically shows the optical path of laser beam splitting means of a laser processing apparatus of the present embodiment. In FIG. 1, the linearly polarized laser beam flux, which is emitted at the pulse emission time of 1 pico second or less from the short pulse oscillating laser main body 1 that continuously emits light pulse of great spatial and temporal energy concentration at a wavelength of 775 nm in the direction indicated by an arrow I in thick line in FIG. 1, is led to the ¼ wavelength plate 2 at the wavelength of 775 nm, and transformed to the circularly polarized light at first.

Then, the laser beam thus transformed to the circularly polarized light is led to the polarized beam splitter 3 where it is resolved on the reflection surface into S polarization component and P polarization component. Thus, the P polarization component is reflected, and the S polarization component is allowed to pass. The laser beam flux is then divided into each of the beams that provide energy in ½, respectively.

After that, each of the laser fluxes in the resolved condition of linear polarization is also led to the ¼ wavelength plate 2, and transformed into the circularly polarized condition. Then, each of them is led to the polarized beam splitter 3 and resolved into the S polarization component and P polarization component on the reflection surface thereof. The P polarization component is reflected, and the S polarization component is allowed to pass. The laser beam is then divided into each of the beams that provide energy in ½, respectively. Therefore, the laser beam I emitted from the laser oscillator is divided into four beams A, B, C and D, each having energy in a ¼ amount, and polarized and propagated by a total reflection mirror 4 in the designated advancing direction.

After that, each of the four laser beam fluxes is led to the photo-mask projection optical system shown in FIG. 2, respectively, thus processing a work piece 12. Here, the description will be made of the structure of the photo-mask projection optical system. In FIG. 2, one of the divided laser beams A, B, C and D is led in the direction indicated by an arrow in FIG. 2 to a zoom beam compressor 110 through a shutter 114 where it is converted into the one having a beam diameter of designated light. Then, it is further led to a mask illumination lens 111 to laser beam having a designated convergent angle for the illumination of the mask pattern portion of the photo-mask 11. At this juncture, depending on the compression ratio of the zoom beam compressor 110 and the focal length of the mask illumination lens 111, the effective NA (number of apertures), with which to process a work piece, is determined finally. In accordance with the NA thus determined, the processing shape of the work piece is determined. To describe this process the other way around, depending on the processing shape of a work piece, the compression ratio of the zoom beam compressor 110 and the focal length of the mask illumination lens 111 are determined or adjusted.

Next, a projection leans 113 projects the laser beam that has passed the mask pattern to focus the pattern image on the surface of the work piece 12, thus performing the beam ablation process by the open and close operation of the shutter 114.

When the beam ablation process is executed by irradiation of the laser beam emitted from the laser oscillator 1 in this manner, any amount of energy other than that is optimally applied to processing a work piece is not necessarily disposed of by attenuation or by use of a light absorbing filter or the like for removal, but controlled in advance to divide energy by means of light polarization immediately after the emission from a laser oscillator so that no excessive energy of laser beam is allowed to be generated. In this way, it is made possible to process plural work pieces at a time.

In this respect, the present invention is not necessarily limited to the processing of a plurality of same work pieces or same processing shapes at a time. In other words, the present invention is applicable to the simultaneous processing by arranging work pieces each formed by different material in different shape.

Also, the present invention is not necessarily limited to the even division of beam energy emitted from a laser oscillator. As a method for dividing energy unevenly, the crystalline axis of a wavelength plate is inclined to the polarizing direction of linearly polarized laser beam emitted from a laser oscillator, thus transforming the laser beam to the one in a state of elliptically polarized light. Then, it becomes possible to divide energy unevenly by use of a polarized beam splitter.

Also, the energy division is not necessarily limited to means of the leaser beam polarization. Although the accuracy of division may become slightly inferior, it is possible to use a beam splitter of non-polarization type (such as a half mirror, for example) in this respect.

What is claimed is:

1. A laser processing apparatus for performing light ablation process using laser beam from a laser oscillator continuously emitting light pulse having large spatial and temporal energy concentration at pulse emission time of 1 pico second or less, comprising:
beam dividing means for dividing laser beam from said laser oscillator into plural beams, and optical systems provided separately for each of said divided beams, wherein
plural processing portions are processed together by irradiating laser to plural processing portions at a time through said optical systems.

2. A laser processing apparatus according to claim 1, wherein said beam dividing means is means for dividing the energy intensity of said laser beam into plural stages, and said energy intensity is equally divided by Nth power of 2 (N being an integer) or divided by an arbitral ratio of energy intensity into multiple stages, not necessarily limited to said equal division.

3. A laser processing apparatus according to claim 1, wherein said beam dividing means is provided with a wavelength plate for changing the states of light polarization and a polarization beam splitter, and structured to divide said laser beam by separating laser beam from said laser oscillator to vertically polarized wave and horizontally polarized wave by use of said means.

4. A laser processing apparatus according to claim 1, wherein said beam dividing means is structured to divide said laser beam by separating laser beam from said laser oscillator by use of a beam splitter for non-polarized light.

5. A laser processing apparatus according to claim 1, wherein said laser oscillator continuously emitting light pulse of large spatial and temporal energy concentration at pulse emission time of 1 pico second or less is a laser oscillator having a space compression device for light propagation.

6. A laser processing apparatus according to claim 5, wherein said space compression device for light propagation comprises means for generating chirped pulse and vertical mode synchronizing means utilizing light wavelength dispersion characteristics.

7. A laser processing apparatus according to claim 1, wherein said laser beam emitted at pulse emission time of 1 pico second or less is laser being oscillated in single mode for the horizontal mode therefor.

8. A laser processing method for performing light ablation process using laser beam from a laser oscillator continuously emitting light pulse having large spatial and temporal energy concentration at pulse emission time of 1 pico second or less, comprising the following steps of:
dividing laser beam from said laser oscillator into plural beams; and
processing plural processing portions altogether by irradiating laser to plural processing portions simultaneously through individual optical system per divided beam.

9. A laser processing method according to claim 8, wherein said laser beam division is provided with a step to separate energy intensity of said laser beam into plural stages, and effectuated by equally dividing said energy intensity to Nth power of 2 (N being integer) or multiply dividing said energy intensity by arbitral energy intensity coefficient, not necessarily limited to said equal division.

10. A laser processing method according to claim 8, wherein said laser beam division is effectuated by the separation of vertically polarized wave and horizontally polarized wave using wavelength plate for changing the states of polarization and polarized light beam splitter.

11. A laser processing method according to claim 8, wherein said laser beam division is effectuated by separating laser beam from said laser oscillator by use of a beam splitter for non-polarized light.

12. A laser processing method according to claim 8, wherein said processing of plural processing portions altogether is a processing of a work piece of one and the same material in one and the same processing shape or a processing of work pieces of different materials in different processing shapes.

13. A laser processing method according to claim 8, wherein said laser oscillator continuously emitting light pulse of large spatial and temporal energy concentration at pulse emission time of 1 pico second or less is a laser oscillator having a space compression device for light propagation.

14. A laser processing method according to claim 13, wherein said space compression device for light propagation comprises means for generating chirped pulse and vertical mode synchronizing means utilizing light wavelength dispersion characteristics.

15. A laser processing method according to claim 8, wherein said laser beam emitted at pulse emission time of 1 pico second or less is laser being oscillated in single mode for the horizontal mode therefor.
